(19) United States
(12) Patent Application Publication
(10) Pub. No.: US 2025/0370680 A1
(43) Pub. Date: Dec. 4, 2025

(54) METHODS FOR CALENDAR-BASED JOB MANAGEMENT IN A PRINTING SYSTEM

(71) Applicant: KYOCERA DOCUMENT SOLUTIONS, INC., Osaka (JP)

(72) Inventors: Jacek Joseph MATYSIAK, Concord, CA (US); Javier A. MORALES, Rochester, NY (US)

(73) Assignee: KYOCERA DOCUMENT SOLUTIONS, INC., Osaka (JP)

(21) Appl. No.: 18/675,597

(22) Filed: May 28, 2024

(51) Int. Cl. G06F 3/12

(52) U.S. Cl. CPC G06F 3/1263; G06F 3/1203

(57) ABSTRACT

A printing system includes a printing device that receives print jobs. The print jobs are placed in a job queue within the digital front end (DFE) of the printing device. The printing device also includes a user interface to display information related to processing the print jobs. Methods executed at the DFE include defining a time period to process the print jobs at the printing device. A production time is estimated for each print job within the job queue related to parameters of the respective print jobs. A magnification level for each print job is generated based on the respective production time. The magnification level determines a visual display within the user interface. As a current job indicator moves over the slots related to the print jobs, the visual display is adjusted according to the magnification level.

### FIELD OF THE INVENTION

The present invention relates to a printing device or system for managing printing operations using calendar-based print job functionality. More particularly, the present invention relates to managing print jobs using a calendar view at the printing device.

### DESCRIPTION OF THE RELATED ART

When managing print jobs via a calendar view on a user interface for a printing device, a problem may be experienced with correlating estimated print times versus what is shown in the user interface. The typical range of print jobs in a high end cut sheet printing device may span anywhere from 5 or more hours for a 50,000 copy job all the way down to 0.4 seconds for a single A4 sheet. The display of jobs with this range of timescales in a single calendar view is problematic. For practical purposes, jobs should display at a minimum height that will show the job name and select attributes, such as copies, media, and the like.

This minimum height, however, may represent a time that far exceeds the estimated time for the job. In calendar applications, meetings are placed next to each other when these situations happen, which is not possible to show for printing device operations.

### SUMMARY OF THE INVENTION

A method for managing printing operations is disclosed. The method includes defining a time period to process a plurality of print jobs within a user interface at a printing device. The method also includes determining an estimated processing time for each print job of the plurality of print jobs. The processing time is related to parameters for the respective print job used by a digital front end (DFE) for the printing device. The method also includes generating a magnification level for each print job of the plurality of print jobs. The magnification level is related to the estimated processing time for the respective print job. The method also includes displaying the plurality of print jobs for the time period within the user interface. The magnification level determines how the respective print job is displayed in the time period by the user interface. The method also includes processing the plurality of print jobs within the DFE of the printing device. The method also includes moving a current job indicator within the user interface for the time period. The method also includes, for a current print job of the plurality of print jobs, adjusting a visual display within the user interface for the current print job according to the magnification level when the current job indicator reaches the current print job within the time period.

A method for managing printing operations is disclosed. The method includes moving a current job indicator along a time period displayed within a user interface for a printing device. The time period includes estimated processing times for a plurality of print jobs and an order for the plurality of print jobs within a job queue of a digital front end (DFE) for the printing device. The method also includes indicating a current print job of the plurality of print jobs within the job queue by the current job indicator. The method also includes determining a magnification level for the current print job within the user interface based on the estimated processing time for the current print job within the DFE. The method also includes adjusting a visual display for the current print job within the user interface based on the magnification level for the current print job.

A printing device is disclosed. The printing device includes a digital front end (DFE) to process a plurality of print jobs for printing operations. The printing device also includes a user interface to display information generated by the DFE. The printing device also includes a processor. The printing device also includes a memory connected to the processor. The memory stores instructions that, when executed on the processor, configure the printing device to define a time period to process the plurality of print jobs within the user interface. The instructions also configure the processor to determine an estimated processing time for each print job of the plurality of print jobs. The processing time is related to parameters for the respective print job used by the DFE. The instructions also configure the processor to generate a magnification level for each print job of the plurality of print jobs. The magnification level is related to the estimated processing time for the respective print job. The instructions also configure the processor to display the plurality of print jobs for the time period within the user interface. The magnification level determines how the respective print job is displayed in the time period by the user interface. The instructions also configure the processor to process the plurality of print jobs within the DFE of the printing device. The instructions also configure the processor to move a current job indicator within the user interface for the time period. The instructions also configure the processor to, for a current print job of the plurality of print jobs, adjust a visual display within the user interface for the current print job according to the magnification level when the current job indicator reaches the current print job within the time period.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1A illustrates a printing system having a printing device for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of a job queue of the DFE used in conjunction with a printing schedule calendar application according to the disclosed embodiments.

FIG. 4 illustrates a block diagram of a defined printing schedule to schedule print jobs using information derived from the job queue according to the disclosed embodiments.

FIG. 5 illustrates a block diagram of the printing schedule having print slots generated using magnification levels using information derived from the job queue according to the disclosed embodiments.

FIG. 6 illustrates a flowchart for managing printing operations by adjusting a visual display of print jobs based on magnification levels according to the disclosed embodiments.

FIG. 7 illustrates a flowchart for adjusting a visual display of a print job within the printing schedule according to the disclosed embodiments.

FIG. 8 illustrates a block diagram of a zooming process in adjusting a visual display of print slot in the printing schedule according to the disclosed embodiments.

FIG. 9 illustrates a block diagram of a break in the timeline for adjusting a visual display of a third slot in the printing schedule according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a printing system in which the level of detail shown in the calendar is adjusted dynamically based on the jobs atop the calendar view. The disclosed embodiments also provide automatic non-contiguous display of jobs whose production time exceeds a defined portion of the user interface.

Jobs may be shown in a calendar view using an application or component within the digital front end (DFE) of a printing device. Instead of having a static zoom level for calendar appointments, the zoom level would be based on one or more factors. For example, the operator may define the nominal number of hours that is shown in the user interface in addition to specifying the calendar settings. If the calendar is empty, then the calendar would set magnification so that the defined number of hours fills the user interface from top to bottom. If the number of scheduled hours is greater, then the operator may scroll up and down to see the rest of the day.

As appointments are added, they are displayed in the user interface. If the estimated time for a job is beneath the aggregation threshold, then the printing system or device will collapse that job in a compact user interface display. The aggregation threshold relates to the height of the job in the user interface is below a specified threshold. As long as the jobs are not actually printing, the disclosed embodiments will retain the magnification level desired to show the number of hours specified in the calendar settings.

Once production or processing starts, the disclosed embodiments determine whether the actively printing job or the job at the top of the job queue can be displayed using the current magnification. If not, then the disclosed embodiments automatically will zoom in so that the job atop of the job queue is shown at the minimum height required to view a job at the user interface.

When that job is complete or printed, the next job moves at the top of the job queue within the DFE. The disclosed embodiments determine whether the next job also may be displayed at the minimum required height. If not, then the disclosed embodiments automatically will further zoom so that the job can be shown at the required height. If the next job exceeds the minimum required height, then the disclosed embodiments may zoom out until one of the following actions happen. The job is displayed at the minimum required height. Alternatively, the calendar user interface displays the nominal number of hours defined in the application settings. The job may still exceed the minimum height but this is acceptable because the desired number of hours is displayed.

As jobs complete, the disclosed embodiments may continue to zoom in and out based on the estimated time for each of the jobs. In other words, the operator does not have to do anything or take any action in order to be able to see jobs at the minimum required height.

In addition to the disclosed dynamic zoom feature, the disclosed embodiments also have a maximum job height. This job height may come into play when zooming in versus the magnification required to show the nominal number of hours in the user interface. If a job exceeds the maximum height then the disclosed embodiments may display a break in the timeline and in the appointment itself so that the job appears non-contiguous.

Thus, the disclosed embodiments address issues with showing estimated print times for jobs that may span from 0.4 seconds to 5+ hours without requiring any active actions from the operator of the printing device. Instead, the disclosed embodiments automatically zoom in and out to ensure that there is visibility to the active jobs. When zooming in, the disclosed embodiments use a non-contiguous display to ensure a manageable amount of scrolling for larger jobs.

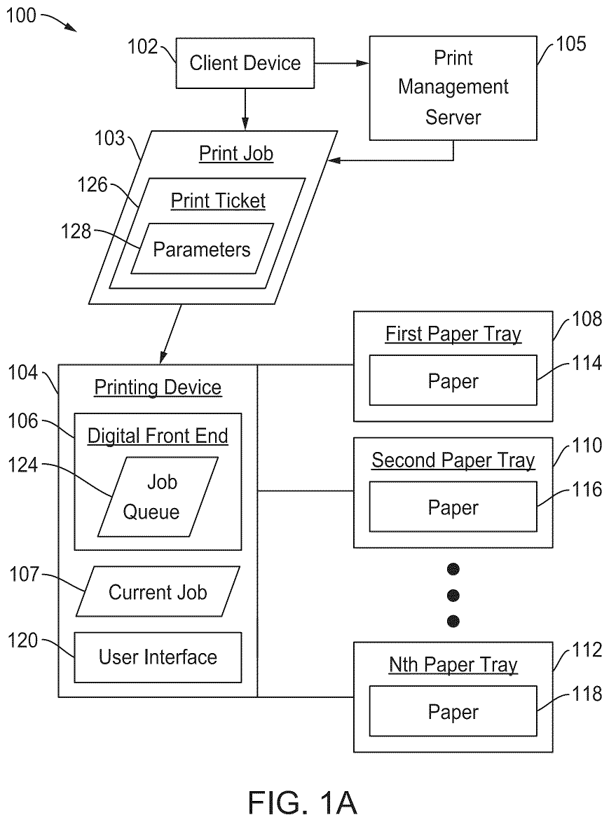

FIG. 1A depicts a printing system 100 for printing documents according to the disclosed embodiments. Printing system 100 includes printing device 104. Printing device 104 is disclosed in greater detail below. Printing device 104 may receive one or more print jobs 103 within printing system 100. For example, client device 102 may generate and send print job 103 to printing device 104. In some embodiments, printing device 104 may be a production printing device in that print jobs are provided through client device 102, which is attached to the printing device. Such a print job may require 1000s of pages or even 100,000pages or more. A print management server 105 also may help with managing printing operations within system 100.

Print job 103 may include a print ticket 126 that sets forth one or more parameters 128 for the print job. For example, print ticket 126 may specify a size for a sheet of print job 103 as well as weight, quality of paper, color of paper, punched holes, and the like. The operator may generate print ticket 126 when submitting print job 103 for printing within printing system 100. Information from print ticket 126, such as one or more parameters 128, may be used to generate a production time to complete printing operations for print job 103.

Printing device 104 may receive print job 103 as it is processing and printing current job 107. Current job 107 may use different paper or media than print job 103. As such, printing device 104 may include a plurality of paper trays to supply papers of various types, sizes, weights, and the like. Thus, printing device 104 includes first paper tray 108 having paper 114, second paper tray 110 having paper 116, and so on to Nth paper tray 112 having paper 118. Current job 107 may use paper from one or more of these paper trays. In some embodiments, paper 114, paper 116, and paper 118 are different types of paper or different media. For example, current job 107 may use paper 116 from second paper tray 110 while print job 103 may require paper 114 from first paper tray 108.

User interface 120 may be in operation panel 208, disclosed below, or part of digital front end (DFE) 106. DFE 106 is disclosed in greater detail below. DFE 106 may process print jobs and act as a controller for printing device 104. Alternatively, user interface 120 may be displayed on client device 102. The disclosed embodiments may use user interface 120 to select papers for print job 103. Further, user interface 120 may display a calendar of print jobs as they are printing at printing device 104. This calendar may include different views depending on parameters for one or print jobs at printing device 104.

DFE 106 also includes print job queue 124. Job queue 124 may be a register that includes print jobs 103 that are waiting to be sent print engine 260, disclosed below. In some embodiments, DFE 106 may include more than one job queue 124. The different job queues may be based on some criterion such as urgent jobs or jobs requiring special finishing or some other operation. Print jobs in job queue 124 may be assigned a status. For example, print jobs within job queue 124 may be designated as being received, parsed, rendered, printed, or already printed. Job queue 124 is a local queue in that it resides on DFE 106.

FIG. 1B depicts a block diagram of DFE 106 according to the disclosed embodiments. DFE 106 includes a receiver 181, a RIP firmware 290, a CMYK data storage 184, an input/output connector 185, and a correcting unit 186. Additional components within DFE 106 may be implemented, as disclosed above and below. For example, although job queue 124 is not shown in FIG. 1B, it is part of DFE 106.

Receiver 181 receives print job 103 received within system 100 and outputs the print job to RIP firmware 290. In some embodiments, receiver 181 receives print job 103 from job queue 124. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When a print color alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing system 100 via input/output connector 185. The print condition information and the print medium type, as well as the rendering data, may be transmitted to a selected printing device within printing system 100. As disclosed above, the rendered data may be in a file format acceptable for a printing device such that the print job is provided directly to the print engine of the printing device.

DFE 106 also includes web user interface 188 that may communicate with other devices within printing system 100, if it is located at a separate device, using, for example, input/output connector 185. Web user interface 188, or web application, allows a user of the DFEs of other printing devices to interact with content or software running on DFE 106.

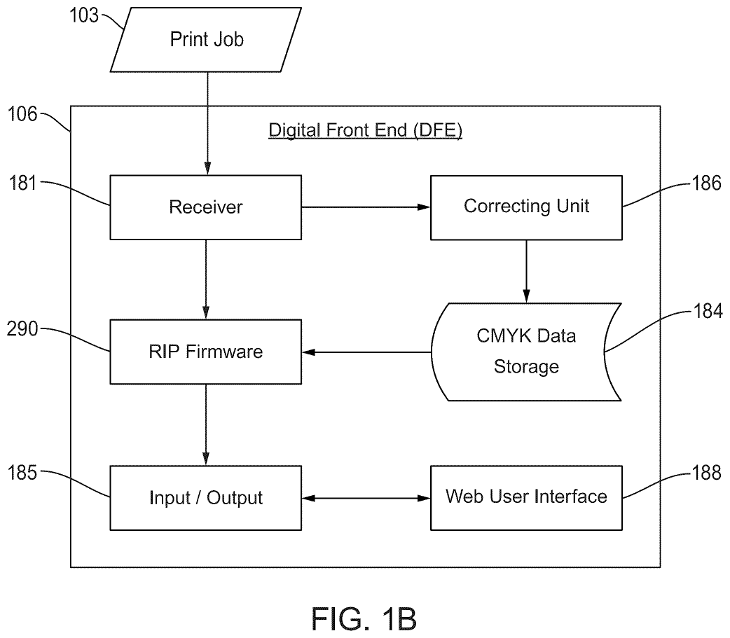

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from DFE 106 and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays, shown as paper trays 108, 110, and 112 in FIG. 1A. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from DFE 106, if applicable. DFE 106 may send calibration and paper catalog information to printing device 104 for display. For example, the operator at DFE 106 may send a calibration to printing device 104. Printing device 104 displays paper type and any other information needed to complete the calibration.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device. Memory unit 206 may store the history of failure events and occurred errors with a timestamp of each error.

Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from DFE 106 as well as other devices within system 100.

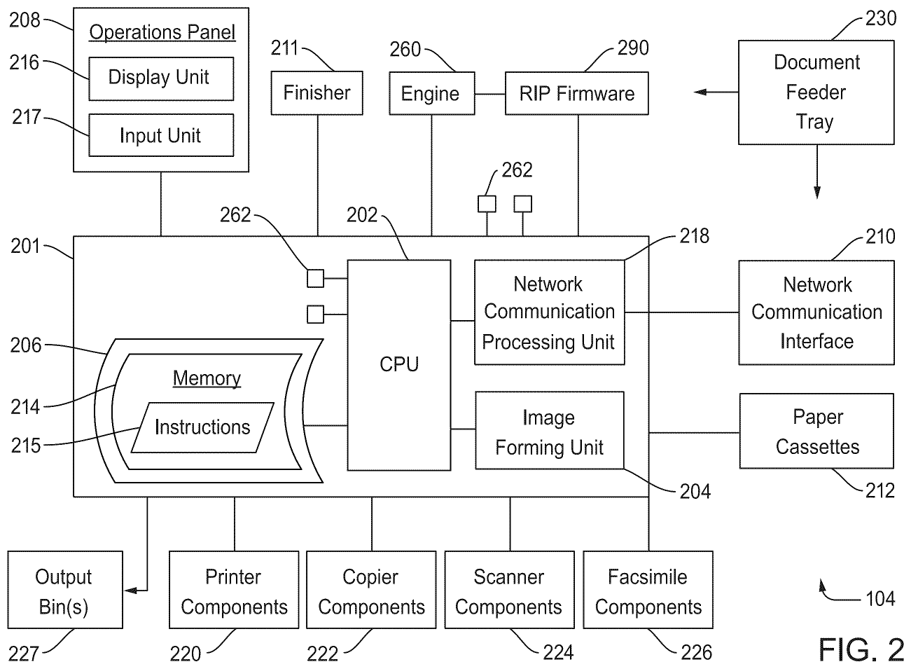

FIG. 3 depicts a block diagram of a job queue 124 of DFE 106 used in conjunction with a printing schedule calendar application 300 according to the disclosed embodiments. Calendar application 300 operates in conjunction with DFE 106 and job queue 124 to schedule and process print jobs at printing device 104. Calendar application 300 interacts with job queue 124 to meet the requirements of the actual jobs within the queue. Calendar application 300 also manages printing schedule interface 306, which is displayed to the operator at printing device 104 through user interface 120. Alternatively, printing schedule interface 306 may be displayed at client device 102.

Calendar application 300, however, resides and is located at DFE 106. In some embodiments, calendar application 300 is not an “application” as a separate component within DFE 106. It may be comprised of components within DFE 106, including processor 202 and memory 206, disclosed above. Instructions 215 are executed to provide the functionality disclosed herein for calendar application 300. Preferably, calendar application 300 operates in DFE 106 to have access to job queue 124. Alternatively, calendar application 300 may operate in management server 105 but has access to DFE 106.

Job queue 124 includes a plurality of print jobs. The print jobs may be ordered in the queue such that a job at the top of job queue 124 is processed and printed first. In the disclosed embodiments, however, print jobs are printed according to a printing schedule determined by calendar application 300. An example printing schedule is disclosed in greater detail below.

Calendar application 300 parses an active print job list within job queue 124 to populate the printing schedule shown within printing schedule interface 306. Estimation module 302 estimates a production time for each print job within job queue 124. For example, job queue 124 may include first print job 103A, second print job 103B, third print job 103C up to Nth print job 103D. Additional print jobs may be within job queue 124 between third print job 103C and Nth print job 103D. Job queue 124 may receive new print job 103E as a new job submitted to printing device 104.

Each print job also may include one or more parameters related to parameters 128 specified in a print ticket 126 with the respective print job. Thus, first print job 103A includes one or more parameters 128A. Second print job 103B includes one or more parameters 128B. Third print job 103C includes one or more parameters 128C. Nth print job 103D includes one or more parameters 128D. New print job 103E includes one or more parameters 128E. It should be noted that parameters 128A-E differ from each other in terms of values for the parameters and the actual parameters themselves. Each print job may have different parameters.

Estimation module 302 may generate a production time for each print job entry within job queue 124. The production time also may be referred to as the print time. An initial estimate for the production time for a print job may be based on parameters provided with the print job, such as the number of pages, copies to print, sheet size, inline finishing, resolution that also may affect print speed, media attributes, and the like. Media attributes may be important as heavier media may run slower in toner devices.

Thus, estimation module 302 may estimate a first production time 304A for first print job 103A. It also may estimate a second production time 304B for second print job 103B. Estimation module 302 also estimates a third production time 304C for third print job 103C and an Nth production time 304D for Nth print job 103D. When new print job 103E is received in job queue 124, estimation module 302 estimates a new production time 304E.

In addition to the initial estimates for production times, estimation module 302 also considers production penalties that are added to the initial estimates. Production penalties may relate to print ticketing exceptions, such as changes in media, plex, inline finishing, and the like. These actions may incur a penalty that is added to the estimated production time. For example, for a change in media, first paper tray 108 may be removed and refilled with the specified media, which results in additional time over the initial estimated time. Parameters 128D for Nth print job 103D may require a change in media at printing device 104 so that estimation module 302 places a production penalty 310 into Nth production time 304D.

Estimation module 302 also may consider periodic maintenance, or maintenance penalties, in addition to the initial estimates. Periodic maintenance, such as head purging, occurs regardless of print jobs in that they are not caused by parameters within a print job. Instead, maintenance penalties are related to actions specified by printing device 104 that incur penalties for printing a job. Thus, estimation module 302 may take into account maintenance schedule 320 when estimating production times for print jobs within job queue 124. For example, periodic maintenance may need to occur according to maintenance schedule 320 during the printing of new print job 103E. Estimation module 302 adds maintenance penalty 312 to new production time 304E for new print job 103E.

Once a production time is estimated for a print job, an appointment for the print job is added to the printing schedule by calendar application 300. This process is disclosed in greater detail below. The print jobs include specified scheduling parameters that also need to be taken into account when scheduling the appointments, such as time slots, available time in the printing schedule, pinned or set print times within the printing schedule, and the like. Calendar application 300 also may take into account policy 308 for printing device 104. Policy 308 may specify actions to be taken when scheduling print jobs, such as scheduling print jobs into a time slot in the printing schedule where the print job may be completed without interruption.

The features and processes used by calendar application 300 are disclosed in greater detail below. Calendar application 300 enables production printing and planning using job queue 124 in DFE 106 and the print jobs within the queue. Calendar application 300 performs interactive planning using actual print jobs as opposed to scheduled information. Further, DFE 106 may include multiple job queues 124 such that estimation module 302 is estimating production times for dozens, hundreds, or more print jobs. Calendar application 300 takes into account a corresponding large number of production times for the print jobs when defining the printing schedule shown in printing schedule interface 306.

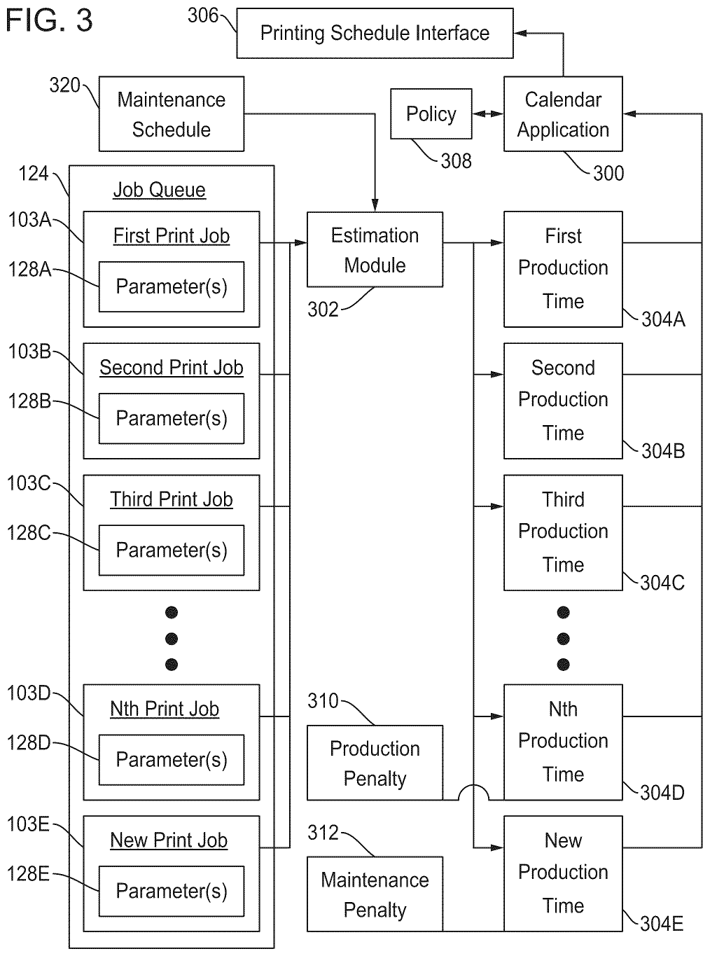

FIG. 4 depicts a block diagram of a defined printing schedule 402 to schedule print jobs using information derived from job queue 124 according to the disclosed embodiments. Printing schedule 402 may be defined, or generated, by calendar application 300 using production times estimates for print jobs within one or more job queues 124. It should be noted that even though FIG. 4 shows a small number of print jobs, printing schedule 402 may include dozens or hundreds of print jobs scheduled for printing at printing device 104.

Printing schedule 402 may be divided into a printing shift 408 and a non-printing shift 410. Printing shift 408 is when print jobs may be printed on printing device 104. Non-printing shift 410 is when no printing operations occur on printing device 104, such as when the print shop is closed or system 100 is not active. Printing shift 408 may start at start time 404 and end at stop time 406.

Calendar application 300 may define a pattern of available work hours for printing device 104, such as how recurring meetings are scheduled. Calendar application 300 may specify the following settings of working days and holidays. Working days may be days of the week during which printing device 104 is expected to be available. Printing schedule 402 reflects one of these days. Printing schedule 402 may include printing shifts 408 and non-printing shifts 410 for the entire week as opposed to a day. Holidays may be days that are exceptions to the above pattern. Calendar application 300 may skip these days. Calendar application 300 also may skip days with events when planning production. An option may be provided to allow operators to subscribe for notification when these exceptions are added by calendar application 300.

For each workday, calendar application 300 may specify start time 404 and stop time 406. Start time 404 and stop time 406 may vary everyday so that calendar application 300 takes these variances into account. For example, Saturdays may be part of the work week and a workday according to calendar application 300. Saturdays, however, start later and end earlier than the other workdays so that its start time 404 and stop time 406 differ from other days within calendar application 300.

Working hours, or times that printing device 104 is available for printing operations, may be defined as printing shift 408. Non-working hours for a given day may be defined by non-working shift 410. Further, calendar application 300 may specify meetings or items that represent non-working hours during the day. For example, lunch or another break within the work day may be designated as a non-working shift 410, or, alternatively, a scheduled downtime for printing device 104.

Calendar application 300 may allow the operators to subscribe to a normal calendar to define non-work hours, or non-working shift 410. This feature allows operators to plan non-work hours using any related application on their devices as calendar application 300 executes on printing device 104, not the devices, such as client device 102, of the operators. Calendar application 300 may skip these times when defining printing schedule 402.

In some embodiments, operators and devices may subscribe to calendar application 300 for updates and changes in printing shift 408 and non-printing shift 410. As print jobs are scheduled within printing schedule 402 by calendar application 300, notifications may be sent to the calendar applications used by the operators or hosted on client devices 102 from calendar application 300. The notifications may be sent on a subscription basis from calendar application 300 at DFE 106 of printing device 104. In other words, printing device 104 is sending notifications and updates via subscription regarding its printing schedule 402. This feature differs from normal print job scheduling operations.

Within printing shift 408 are time, or printing, slots. In most instances, time slots are not defined. In other words, the number of time slots and duration of each time slot varies throughout printing shift 408. Printing shift 408, however, is defined between start time 404 and stop time 406. The number of time slots within printing shift 408 corresponds to the number of print jobs that are scheduled by calendar application 300 to be printed. Calendar application 300 schedules print jobs to be printed with printing schedule 402 according to the production times for the print jobs and according to policy 308.

For example, first print job 103A may be scheduled by calendar application 300 within a first slot 412 that starts at time T1 and is estimated to print within first production time 304A, which ends at time T2. Second print job 103B may be scheduled by calendar application 300 to start printing at time T2, after completion of printing operations for first print job 103A. Second print job 103B is estimated to print within second production time 304B, which ends at time T3. Times T2 and T3 may vary depending on the situation in printing first print job 103A or second print job 103B. If there is some delay in processing these jobs, then calendar application 300 will move time T2 or time T3, accordingly.

Calendar application 300 also may consider specified times for specific print jobs when defining printing schedule 402. These print jobs may be known as pinned print jobs in that they are assigned times within printing schedule 402 that may not be moved due to delays or other issues within the printing schedule. For example, Nth print job 103B may be a pinned print job having a specified time T4 for printing operations to begin. This time also may correspond to a third slot 418 defined by calendar application 300. Calendar application 300 allocates time for printing operations according to Nth production time 304D, or until time T5.

Specified times may be given for print jobs due to parameters that require certain features that are available at those times. Further, a customer may expect completion of the print job at a specific time. In some embodiments, printing device 104 includes media, such as paper 114 in first paper tray 108 that is required to complete the print job. These jobs are pinned to the specified times in printing schedule 402.

For third print job 103C, it may need to be shifted to another time slot within printing schedule 402 based on the specified time for processing Nth print job 103D. For example, third production time 304C, as estimated, may exceed the amount of time within printing schedule 402 available between time T3, or the estimated end of processing print job 103B, and time T4, or the specified time to print Nth print job 103D. Thus, calendar application 300 may schedule third print job 103C to begin printing operations at the first time available after completion of Nth print job 103D, which may be time T6. Fourth slot 422 may be defined within printing schedule 402 for third print job 103C.

A maintenance slot 420 may be defined within printing schedule 402 for periodic maintenance on printing device 104. It also may allow an operator to refill paper trays or change media. Maintenance slot 420 may be scheduled, or pinned, within printing schedule 402. Alternatively, it may take place after completion of a number of print jobs within job queue 124 based on the estimated resources needed for each job, such as the number of sheets, ink, toner, and the like.

New print job 103E is received within job queue 124. Alternatively, new print job 103E may be within job queue 124 but considered for printing schedule 402 after first print job 103A to Nth print job 103D. Calendar application 300 may determine that gap 416 between second slot 414 for second print job 103B and third slot 418 for Nth print job 103D exists. Gap 416 may exist between time T3 at the estimated completion of second print job 103B and the start of printing operations for Nth print job 103D within defined third slot 418 of printing schedule 402.

As a result, calendar application 300 determines that new production time 304E estimated for new print job 103E is within the amount of time defined for gap 416. In other words, new print job 103E may be processed and printed in the time period between time T3 and time T4. Thus, calendar application 300 defines a time slot for new print job 103E within gap 416. Calendar application 300 also reorders the print jobs within job queue 124 to place new print job 103E behind first print job 103A and second print job 103B, but in front of third print job 103C and Nth print job 103D. Thus, the order of print jobs within job queue 124 of DFE 106 may be reordered based on printing schedule 402 defined by calendar application 300.

Printing schedule 402 also includes a plurality of slots 424 between time T7 and time T8. Multiple print jobs may be processed in plurality of slots 424. Further, time T7 may be moved as previous print jobs are completed. As operations complete, current job indicator 450 may move along printing schedule 402 as displayed within printing schedule interface 306. Calendar application 300 moves current job indicator 450 in real time to show where in printing schedule 402 that printing device 104 is. Further, calendar application 300 may move times as current job indicator 450 moves within printing schedule 402 to update estimated times and the schedule based on delays, slower speeds in printing operations, and the like.

As disclosed above, production penalties 310 and maintenance penalties 312 may manifest themselves as printing operations are completed at printing device 104. These penalties may be estimated with the production times estimated for print jobs. Alternatively, they may be accounted for during printing operations within printing shift 408. For example, production penalty 310 may occur during the processing of Nth print job 103D within third slot between times T4 and T5. If third print job 103C had been printing between these times, then production penalty 310 would be included in third production time 304C. Thus, calendar application 300 may account for delays in scheduling print jobs and defining printing schedule 402 as well are reordering job queue 124 as a result.

As current job indicator 450 moves within printing schedule 402, calendar application 300 may determine that a print job cannot be printed within its slot. For example, new print job 103E is assigned to be printed in the period between time T3 and time T4, or gap 416. Delays in processing second print job 103B causes second slot 414 to move its estimated stop time at time T3 further down in printing schedule 408. Calendar application 300 determines that new production time 304E estimated for new print job 103E will exceed the time available between adjusted time T3 and time T4 for starting printing operations for third slot 418, or Nth print job 103D.

As a result of the adjustment within printing schedule 402, new print job 103E may be moved from its slot to another time, such as one within plurality of slots 424. Gap 416 now exists again within printing schedule 402. Another print job may be scheduled during that time by calendar application 300. Calendar application 300 replaces a moved print job with a new print job according to the disclosed embodiments. Alternatively, new print job 103E or third print job 103C may be moved to second slot 414 behind first slot 412 to begin printing operations at T2 if second print job 102B becomes unavailable.

In some embodiments, calendar application 300 may split printing operations for a print job between printing times, or slots, within printing schedule 402. For example, first print job 103A in first slot 412 may experience delays during printing operations. As current job indicator 450 moves within printing schedule 402, calendar application 300 updates estimated production times based on feedback from print engine 260 and job queue 124. Using the example, time T2 for beginning second slot 414 defined from second print job 103B may be moved further down within printing schedule 402.

At some point, calendar application 300 determines that second production time 304B estimated to complete second print job 103B exceeds the amount of time between time T2 to start second slot 414 and time T4 for the start for printing Nth print job 103D at a specified time within printing schedule 402. Calendar application may split printing operations so that a first part of printing second print job 103B is done within second slot 414 defined for second print job 103B. A second part of printing second print job 103B may be defined elsewhere in printing schedule 402, such as one of plurality of slots 424. If fourth slot 422 is not defined for third print job 103C, then the second part may be defined after time T6. Thus, a print job may be printed within two slots of printing schedule 402.

Calendar application 300 also may consider policy 308 in defining time slots for print jobs within printing schedule 402. Policy 308 may include one or more statements or rules governing how print jobs are to be treated in defining printing schedule 402. For example, policy 308 may include a rule to ensure job contiguity so that print jobs are scheduled into a time period in printing shift 408 so that the print job may be processed without interruption. For example, new print job 103E may be assigned to gap 416 if its estimated new production time 304E will allow it to be printed between times T3 and T4. If not, then policy 308 would dictate that calendar application 300 define a time for printing new print job 103E elsewhere, such as one of plurality of slots 424.

If multiple print jobs may be scheduled within gap 416, then policy 308 may instruct calendar application 300 to schedule the print job that does not require a media change or minimizes a media change. For example, third print job 103C and new print job 103E may fit within times T3 and T4 of gap 416. Third print job 103C would require a media change, which introduces a production penalty 310 into third production time 304C. New print job 103E does not require a media change after second print job 103B. Thus, calendar application 300 schedules new print job 103E into gap 416.

Policy 308 also may provide instructions to calendar application 300 to print jobs in a defined sequence. For example, print jobs that cannot be completed before non-work hour meetings are automatically divided into multiple appointments within printing schedule 402.

As disclosed above, a print job may be divided into two slots to minimize gaps in printing schedule 402. Alternatively, policy 308 may allow for stop time 406 to be adjusted, or a time before a non-work slot, such as maintenance slot 420, to be adjusted to accommodate the print job.

For example, time T5 may be moved downwards within printing schedule 402 if the print job assigned in defined third slot 418 goes longer than estimated by its production time. Policy 308 may instruct calendar application 300 to make this adjustment. In other embodiments, non-printing shift 410 may include a no print slot 426. Policy 308, however, may move a print job to no print slot 426, or at least define a print job to be processed during that time period. Policy 308 also may distinguish between non-work time in making decisions. For example, time T5 may moved but time T8 for stop time 406 of printing shift 408 may not be moved.

Policy 308 also may enable “one-click” optimizations to reduce the amount of down time of printing device 104 within printing schedule 408. Policy 308 may specify to calendar application to minimize idle time by ensuring that all work hours within printing shift 408 are filled as much as possible. Thus, calendar application 300 may have settings in policy 308 related to print job completion. For example, policy 308 may specify that a print job must start production within a certain amount of time after it is received at printing device 104 or within job queue 124. Parameters 128 also may be used to determine deadlines that calendar application 300 may use to define a time slot or time period to schedule the print job.

It should be noted that use of the term time slots or slots does not include that these slots are defined within printing schedule 402 before receipt of print jobs within job queue 124. These terms are used to show that print jobs are scheduled at times within printing schedule. A time slot is defined by calendar application for each print job. The defined time slots are adjusted, deleted, and created according to the information retrieved from the print jobs within job queue 124 by calendar application 300.

FIG. 4 depicts a block diagram of printing schedule 402 having print slots generated using magnification levels using information derived from job queue 124 according to the disclosed embodiments. As disclosed above, production times may be estimated using information derived from the print jobs in job queue 124. The production times may be used to generate magnification levels that are then used in displaying the print jobs in job queue in printing schedule 402 within printing schedule interface 306.

The operator would define the nominal number of hours that should be shown in printing schedule interface 306. For example, hours 504 may be defined and displayed within the interface using calendar application 300. Hours 504 may not show the entire printing schedule for a printing shift 408, but hours defined to display. The magnification level of the interface may adjust within the interface to show the defined hours. In this instance, hours 504 may show between 0800 to 1130, or a morning shift. If printing schedule 402 is empty, then calendar application 300 would set the magnification so that the defined number of hours 504 fills printing schedule interface 306 from top to bottom. The operator also may scroll up and down within printing schedule interface 306 to see the rest of printing shift 408.

As appointments are added, or print jobs are added to printing schedule 402, they are shown in printing schedule interface 306. For example, first production time 304A may be used by calendar application 300 to generate a first magnification level 502A for first print job 103A. The magnification level may be based on the estimated time for the production time as determined using information from DFE 106 and job queue 124 along with the defined hours 504 in the interface. A magnification level for hours 504 of two hours would differ from a magnification level for hours 504 of six hours, even though the estimated production time for the job would remain the same.

This process is repeated for all the print jobs to be added to printing schedule 402. Second production time 304B is used to generate second magnification level 502B for second print job 103B. Third production time 304C is used to generate third magnification level 502C for third print job 103C. This process may be repeated until it reaches Nth print job 103D, which has an Nth magnification level 502D based on Nth production time 304D.

The magnification levels are used to display the print jobs on printing schedule interface 306. As long as print jobs are not actually printing, the disclosed embodiments will retain the magnification level generated above required to show the number of hours 504 specified in the calendar settings. Once production starts, calendar application 300 will determine whether the actively printing job or the job at the top of job queue 124 can be displayed at a minimum required height. This process is disclosed in greater detail below.

For example, first print job 103A is scheduled to be printed in first slot 412 starting at 0800. First production time 304A may be estimated to be thirty minutes, or from 0800 to 0830. First magnification level 502A is set to show this relationship in printing schedule 402. Second print job 103B then may be scheduled to print in second slot 414 starting at 0830. Second production time 304B may be estimated to be fifteen minutes, or from 0830 to 0845. Second magnification level 502B also is set to show this relationship in printing schedule 402.

A maintenance slot 420 may be schedule from 0845 to 0900 and shown at the appropriate magnification level within printing schedule 402. Third print job 103C then may be scheduled to print in third slot 418 starting at 0900. It may be appreciated that this arrangement of print jobs does not correspond to the arrangement disclosed in FIG. 4. Third production time 304C may be estimated to be forty-five minutes, or from 0900 to 0945. Third magnification level 502C shows this relationship in printing schedule 402.

The next print job in job queue 124 may be Nth print job 103D, which is scheduled to print in fourth slot 422 starting at 0945. Nth production time 304D may be less than one minute. Thus, Nth magnification level 502D may be small to show this relationship within the total time period shown for hours 504.

As current job indicator 450 moves within printing schedule 402, the display of the corresponding print job may be adjusted according to the disclosed embodiments. For example, fourth slot 422 may be so small compared to hours 504 that it is not displayed within printing schedule 402 that allows it to be seen. Alternatively, third slot 418 may exceed a magnification level threshold so that it is displayed within printing schedule 402 with a break to fit on a screen for printing schedule interface 306. These embodiments are disclosed in greater detail below. Policy 308 may define these thresholds for magnification levels used within printing schedule 402.

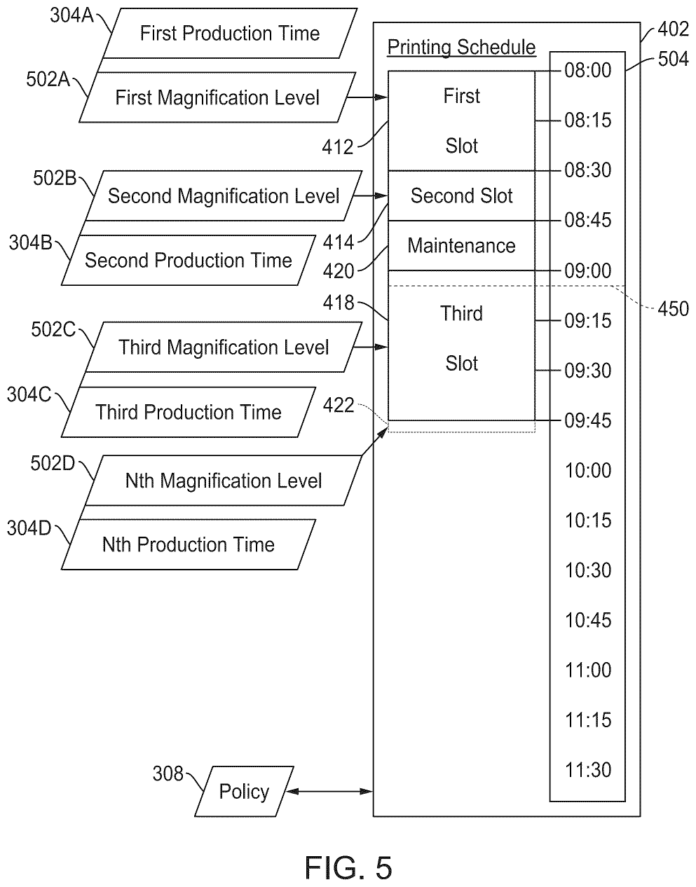

FIG. 6 depicts a flowchart 600 for managing printing operations by adjusting a visual display of print jobs based on magnification levels according to the disclosed embodiments. Flowchart 600 may refer to FIGS. 1A to 5 for illustrative purposes. Flowchart 600, however, is not limited to the embodiments disclosed by FIGS. 1A to 5.

Step 602 executes by defining a time period to process a plurality of print job at printing device 104. For example, hours 504 may be defined for displaying that portion of printing schedule 402. Step 604 executes by receiving print jobs at printing device 104. For example, first print job 103A, second print job 103B, third print job 103C up to Nth print job 103D may be received and placed in job queue 124 within DFE 106.

Step 606 executes by determining an estimated production time for each print job within job queue 124. Referring to FIG. 3, estimation module 302 may generate first production time 304A for first print job 103A, second production time 304B for second print job 103B, third production time 304C for third print job 103C, up to Nth production time 304D for Nth print job 103D.

Step 608 executes by generating a magnification level for each print job based on the respective production time estimated for the print job. Magnification level may correspond to the amount of time to be taken by the production time. Magnification level relates to the amount of the displayed time taken within printing schedule 402. For example, first print job 103A has a first magnification level 502A based on first production time 304A. First magnification level 502A indicates to calendar application 300 of the level of display within printing schedule interface 306 for the print slot for first print job 103A.

Step 610 executes by displaying the print jobs within job queue 124 for the defined time period, or hours 504, within printing schedule interface 306 for printing schedule 402. The magnification level for each print job determines how the respective print job is displayed. The magnification level may correspond to the time units used by hours 504. The magnification levels may stay the same even if hours 504 change to display the time needed to print each respective job.

Step 612 executes by processing the print jobs at printing device 104 according to printing schedule 402. As each print job is processed, current job indicator 450 may highlight the processing print job within printing schedule interface 306 for printing schedule 402. Step 614 executes by moving current job indicator 450 within printing schedule interface 306 for the time period, or hours 504. Current job indicator 450 may move “down” printing schedule 402 as time passes within printing shift 408, and shown within hours 504.

Step 616 executes by adjusting the visual display of the current print job being processed as shown by current job indicator 450 according to the magnification level for the respective print job. As current job indicator 450 “passes over” a slot in printing schedule 402, the display for the print job may be adjusted according to its magnification level so that the print job may be shown. This adjustment may take into account making currently processed print jobs that do not display normally for hours 504 fit within the interface.

For example, if the current magnification level for a print job does not allow it to be displayed in a meaningful fashion by being too small or too large, then the disclosed embodiments will adjust the visual display according to the magnification level to make the display of the print job fit within the interface. These embodiments are disclosed in greater detail below.

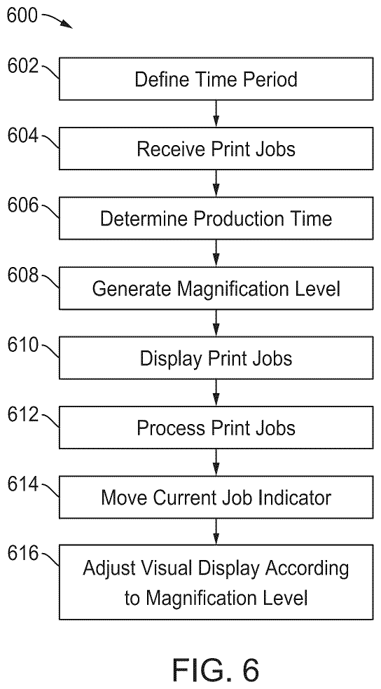

FIG. 7 depicts a flowchart 700 for adjusting a visual display of a print job within the printing schedule according to the disclosed embodiments. Flowchart 700 may refer to FIGS. 1A to 6 for illustrative purposes. Flowchart 700, however, is not limited to the embodiments disclosed by FIGS. 1A to 6.

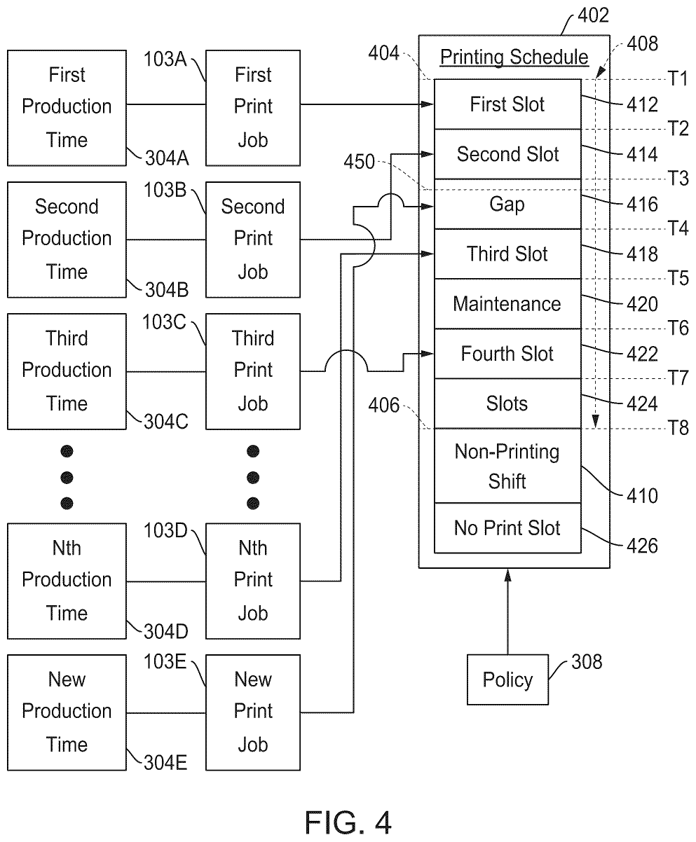

Step 702 executes by moving current job indicator 450 over a display for a print job in printing schedule interface 306 of printing schedule 402. Referring to FIG. 5, current job indicator 450 may move over first slot 412 for first print job 103A, second slot 414 for second print job 103B, third slot 418 for third print job 103C, and fourth slot 420 for Nth print job 103D. As a new print job is engaged within the display for printing schedule 402, calendar application 300 may perform actions to adjust the display on the screen to the operator to highlight the currently processed print job.

Step 704 executes by determining a height for the print job within the display according to its magnification level and the defined hours being displayed. For example, if the number of hours 504 is 5 or more, then a height of the slot for the print job being displayed may be small and not readily visible if it is only 1 minute or less, even if displayed according to its magnification level. “Height” may refer to the amount of visual display space on the screen for the slot, such as the number of pixels being used to show the print job in the calendar for printing schedule 402.

Step 706 executes by determining whether the determined height, or amount of screen, needed to show the current print job at its magnification level is within a minimum required height, such as a minimum height threshold defined by policy 308. The determined height may be based on the absolute height of the appointment within the user interface. If the number of hours 504 is four hours, then the minimum height for displaying a print job according to its magnification level may correspond to an appointment height of 10 minutes on the screen of the interface. If the number of hours is one hour, then the minimum height may correspond to an appointment height of 3 minutes on the screen of the interface.

Calendar application 300 may analyze the magnification level for the current print job and determine whether it will allow display of the print job within the interface at the minimum height, as determined by the period of time currently being displayed in the interface. If step 706 is no, then step 708 executes by adjusting the display of the slot by zooming in to further enhance the display of the time period for the print job to meet the minimum required height. Once calendar application 300 “zooms in” according to a specified magnification level, such as 10×, flowchart 700 returns to step 706 to determine if the new display level meets the minimum required height. The disclosed embodiments then may zoom in as much as needed until the current job may be displayed at the minimum required height.

If step 706 is yes, then step 710 executes by determining whether the visual display of the current print job in the slot highlighted by current job indicator 450 is within a maximum height value. If not then the display of the current print job according to its magnification level exceeds a maximum height allowed for viewing print jobs within the interface, such as specified by policy 308 for calendar application 300. In other words, the disclosed embodiments do not want to display a print job that takes up the entire screen of the interface.

If step 710 is no, then step 712 executes by adjusting the visual display of the print job within the interface with a break in the timeline and in the slot itself so the print job appears non-contiguous. In this manner the displayed processing of the print job does not engulf the entire screen according to its magnification level. Flowchart 700 then proceeds to step 716.

If step 710 is yes, then step 714 executes by displaying the current print job according to its current magnification level. If calendar application 300 zoomed in to show the print job at the minimum height, then the zoom magnification level is applied to adjust the display of the print job. Once processing is complete, current job indicator 450 may move to the next slot for the next print job. Step 716 executes by determining whether the interface needs to zoom out based on any zooming in performed in step 708. If yes, then step 718 executes by adjusting the visual display of printing schedule 402 to zoom back out. If step 716 is no, then step 720 executes by waiting for the next slot to be highlighted by current job indicator 450.

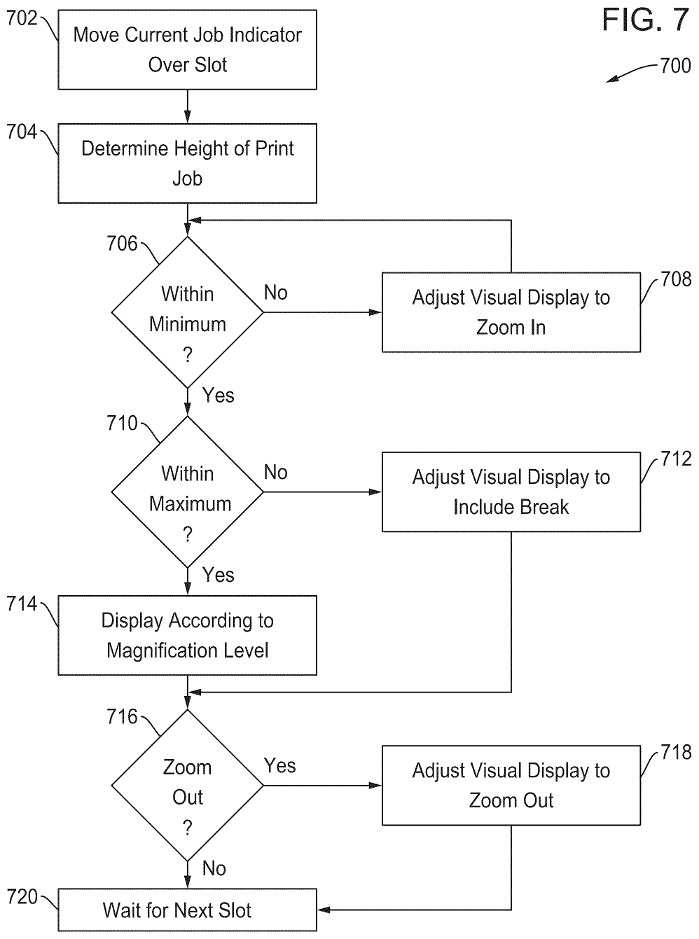

FIG. 8 depicts a block diagram of a zooming process in adjusting a visual display of fourth slot 422 in printing schedule 402 according to the disclosed embodiments. The features disclosed by FIG. 8 may be implemented in steps 616 and 706-707 disclosed above. Using fourth slot 422 as an example, this entry within printing schedule 402 for Nth print job 103D has a height 802 after Nth magnification level 502D is applied as current job indicator 450 highlights fourth slot 422. Calendar application 300, for example, may determine that height 802 does not meet the specified minimum height to display within printing schedule interface 306 for printing schedule 306.

The disclosed embodiments apply zoom operation 808A to enlarge the display of fourth slot 422 by some amount of magnification, such as 10× to have a height 804 within printing schedule interface 306 for enlarged fourth slot 422. In some embodiments, height 804 may still be below the specified minimum height, then the disclosed embodiments apply an additional zoom operation 808B to further enlarge the display of fourth slot 422 by another magnification amount of 10×. After zoom operation 808B, fourth slot 422 may have a height 806 that meets the minimum height requirement set forth by calendar application 300. Thus, the disclosed embodiments may zoom in to adjust the display for a print job in printing schedule 402 as much as needed.

Current job indicator 450 moves “down” the displayed image for fourth slot 422. The adjusted display provides a clearer representation where printing device 104 is in the printing process than if fourth slot 422 was displayed at height 802. Thus, the minimum height requirement also may be based on showing the movement of current job indicator 450 in a precise manner acceptable to the operator. As current job indicator 450 moves off fourth slot 422, calendar application 300 will not continue to highlight the slot. Thus, zoom out operation 810 is executed to go back to the default view of printing schedule 402. In some embodiments, zoom out operation 810 may occur iteratively back to the default view within printing schedule interface 306.

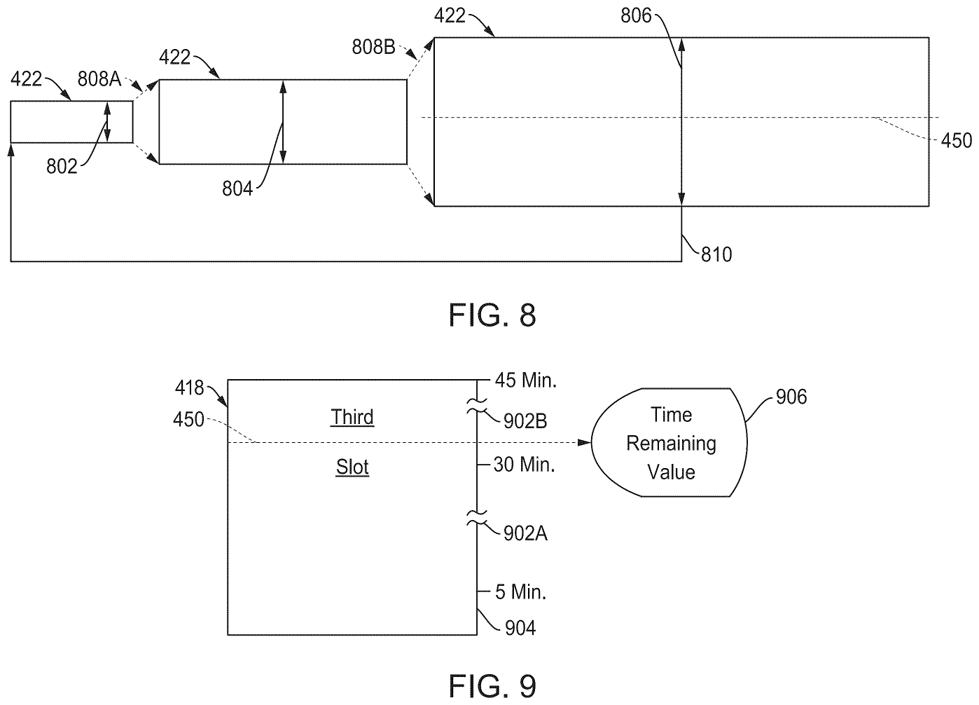

FIG. 9 depicts a block diagram of a break in the timeline for adjusting a visual display of third slot 422 in printing schedule 402 according to the disclosed embodiments. The features disclosed by FIG. 9 may be implemented in steps 616 and 716-718 disclosed above. In some embodiments, the magnification level for a print job displayed in printing schedule interface 306 may exceed a maximum height requirement. The disclosed embodiments, using calendar application 300, may insert a break 902 to adjust the display of the slot after third magnification level 502C is applied.

Current job indicator 450 may highlight third slot for third print job 103C. Third print job 103C may be scheduled to execute between 0900 and 0945 based on third production time 304C. Third magnification level 502C may result in a height for third slot 418 exceeding a specific maximum height, such as the currently defined hours 504 within printing schedule interface 504. Display of third slot 418 would not be contained in the interface.

The disclosed embodiments may insert a break, shown as break 902A in the timeline shown for third slot 418. As current job indicator 450 moves down the timeline, once it reaches the break as shown by 902A, the break may move relative to the current job indicator 450, as shown by 902B. For example, current job indicator 450 may move along timeline 904 for third slot 418. The top amount for timeline 904 may be 45 minutes. A time remaining value 906 may be displayed as processing occurs for third print job 103C. If processing increases or decreases based on issues at printing device 104, time remaining value 906 may reflect the change in processing time.

As shown along timeline 904, after the break shown by 902A, about 5 minutes will remain for processing third print job 103C. The spot right above 902A indicates 30 minutes left on timeline 904. Thus, the break adjusts the visual display of third slot 418 and makes continuous adjustments as the job is processed. Once current job indicator 450 reaches the 30 minute mark on timeline 904, the amount shown may be adjusted to 25, 20, or some other value for minutes. Upon reaching the break shown by 902A, the disclosed embodiments may move the break as shown by 902B so that current job indicator 450 displays time remaining value 906 for 5 minutes and below. Upon completion of third print job 103C, the display of third slot 418 may return to the default display for printing schedule 402 within defined hours 504.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations, the method comprising:
defining a time period to process a plurality of print jobs within a user interface at a printing device;
determining an estimated production time for each print job of the plurality of print jobs, wherein the production time is related to parameters for the respective print job used by a digital front end (DFE) for the printing device;
generating a magnification level for each print job of the plurality of print jobs,
wherein the magnification level is related to the estimated production time for the respective print job;
displaying the plurality of print jobs for the time period within the user interface, wherein the magnification level determines how the respective print job is displayed in the time period by the user interface;
processing the plurality of print jobs within the DFE of the printing device;
moving a current job indicator within the user interface for the time period;
for a current print job of the plurality of print jobs, adjusting a visual display within the user interface for the current print job according to the magnification level when the current job indicator reaches the current print job within the time period.

2. The method of claim 1, further comprising wherein adjusting the visual display includes determining whether the magnification level is above a minimum height threshold for displaying within the user interface.

3. The method of claim 2, wherein adjusting the visual display further includes expanding the visual display for the current print job within the user interface if the magnification level is below the minimum height threshold.

4. The method of claim 2, wherein adjusting the visual display further includes displaying the visual display for the current print job at a minimum size within the user interface.

5. The method of claim 1, further comprising determining the estimated production time is below an aggregation threshold.

6. The method of claim 5, further comprising placing the visual display for the respective print job into a compact aggregated display having at least one other visual display for at least one other print job.

7. The method of claim 1, further comprising detecting a delay for an actual production time with the DFE of the printing device for the current print job.

8. The method of claim 7, further comprising adjusting the visual display for the current print job within the user interface according to the actual production time.

9. The method of claim 8, further comprising reordering the plurality of print jobs within the time period based on the actual production time.

10. The method of claim 1, further comprising determining the estimated production time for the respective print job is greater than a maximum job threshold.

11. The method of claim 10, further comprising adjusting the visual display for the respective print job to include a break in the visual display.

12. The method of claim 11, wherein adjusting the visual display for the current print job when the break is reached within the time period by the current job indicator.

13. A method for managing printing operations, the method comprising:
moving a current job indicator along a time period displayed within a user interface for a printing device, wherein the time period includes estimated production times for a plurality of print jobs and an order for the plurality of print jobs within a job queue of a digital front end (DFE) for the printing device;
indicating a current print job of the plurality of print jobs within the job queue by the current job indicator;
determining a magnification level for the current print job within the user interface based on the estimated production time for the current print job within the DFE; and
adjusting a visual display for the current print job within the user interface based on the magnification level for the current print job.

14. The method of claim 13, further comprising determining whether the magnification level is above a minimum height threshold for displaying within the user interface.

15. The method of claim 13, further comprising expanding the visual display for the current print job if the magnification level is below the minimum height threshold.

16. The method of claim 13, further comprising detecting a delay for an actual production time with the DFE of the printing device for the current print job.

17. The method of claim 16, further comprising adjusting the visual display for the current print job within the user interface according to the actual production time.

18. The method of claim 17, further comprising modifying the order of the plurality of print jobs based on the delay for the actual production time.

19. The method of claim 13, further comprising
determining the estimated production time for the current print job is greater than a maximum height threshold; and
adjusting the visual display for the respective print job to include a break in the visual display.

20. A printing device comprising;
a digital front end (DFE) to process a plurality of print jobs for printing operations;
a user interface to display information generated by the DFE;
a processor; and
a memory connected to the processor, the memory storing instructions that, when executed on the processor, configure the printing device to
define a time period to process the plurality of print jobs within the user interface;
determine an estimated production time for each print job of the plurality of print jobs, wherein the production time is related to parameters for the respective print job used by the DFE;
generate a magnification level for each print job of the plurality of print jobs,
wherein the magnification level is related to the estimated production time for the respective print job;
display the plurality of print jobs for the time period within the user interface, wherein the magnification level determines how the respective print job is displayed in the time period by the user interface;
process the plurality of print jobs within the DFE of the printing device;
move a current job indicator within the user interface for the time period;
for a current print job of the plurality of print jobs, adjust a visual display within the user interface for the current print job according to the magnification level when the current job indicator reaches the current print job within time period.
